(19) United States
(12) Patent Application Publication
(10) Pub. No.: US 2022/0269650 A1
(43) Pub. Date: Aug. 25, 2022

(54) DEVICE, SYSTEM AND METHOD FOR PROVIDING RESPONSES TO QUERIES

(71) Applicant: REIMAGINE AI INC., Montreal (CA)

(72) Inventor: David USHER, Outremont (CA)

(21) Appl. No.: 17/671,164

(22) Filed: Feb. 14, 2022

Related U.S. Application Data
(60) Provisional application No. 63/151,276, filed on Feb. 19, 2021.

(51) Int. Cl. G06F 16/14; G06F 16/13

(52) U.S. Cl. CPC G06F 16/148; G06F 16/13

(57) ABSTRACT

A device, system and method for providing responses to queries is provided. a computing device provides, to a first device associated with a first account, one or more predetermined queries stored at one or more memories; receives, from the first device, responses to the predetermined queries; stores, at the memories, the responses associated with respective queries and the first account, the responses representative of an electronic virtual being engine associated with the first account; receives, from a second device, a query associated with the electronic virtual being engine; and responsive to determining a lack of correspondence between the one or more predetermined queries and the query: provides the query to the first device; and responsive to receiving a response to the query from the first device, stores, at the memories, the response associated with the query and the first account, the response to further represent the electronic virtual being engine.

### BACKGROUND

Chatbots, and the like, may be used to provide responses to queries, but such responses need to be prepopulated, which can be a time consuming process.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a system for providing responses to queries, according to non-limiting examples.

FIG. 2 depicts a block diagram of a computing device for providing responses to queries, according to non-limiting examples.

FIG. 3 depicts a method for providing responses to queries, according to non-limiting examples.

FIG. 4 depicts the system of FIG. 1 implementing a method for providing responses to queries, according to non-limiting examples.

FIG. 5 depicts the system of FIG. 1 continuing to implement a method for providing responses to queries, according to non-limiting examples.

FIG. 6 depicts the system of FIG. 1 continuing to implement a method for providing responses to queries, according to non-limiting examples.

FIG. 7 depicts the system of FIG. 1 populating an electronic memory-bank, according to non-limiting examples.

### DETAILED DESCRIPTION

Chatbots, and the like, may be used to provide responses to queries, but such responses need to be prepopulated, which can be a time consuming process, especially for particular applications that involve electronic virtual beings. In a particular process, audio and/or video recordings of a real world counterpart of an electronic virtual being may be populated at a memory and, human guesses may be made as to the content thereof, which may also be stored at the memory. Hence, when a question is asked of the electronic virtual being and/or the chatbot, the recording may be provided, assuming the question corresponds to the content of the guess. However, such recordings are not generally changeable, are very hard to update and/or change and/or search, and furthermore such recordings generally consume a lot of memory and/or may use a lot of bandwidth to provide the recordings when transmitted in a communication network.

As such, provided herein is a device, system and method for providing responses to queries which may be used to represent an electronic virtual being (e.g. provided as electronic virtual being engine, including, but not limited to, a chatbot engine, that includes hardware and/or a combination of hardware and software). In particular, a computing device, provided herein, provides predetermined queries to a first communication device, for example as organized into categories, and receives responses to the queries, which are stored at one or more memories, to represent an electronic virtual being implemented via the electronic virtual being engine. The first communication device may be operated by a real-world counterpart and/or first communication device may be operated by an expert on the real-world counterpart, and the like, among other possibilities.

The computing device may receive a query from a second communication device, the query associated with the electronic virtual being engine. For example, the electronic virtual being engine may be used to receive the query, with the electronic virtual being engine provided in the form of the chatbot engine as implemented by the computing device. Responsive to determining a lack of correspondence between the one or more predetermined queries and the query, the computing device may provide the query to the first communication device and receive a response thereto. The computing device may store the response at the one or more memories, the response associated with the query and the first account, the response to further represent the electronic virtual being engine. The computing device may further provide the response from the first communication device to the second communication device as a response to the query therefrom, the response represented as being from the electronic virtual being engine. As such, a feedback loop occurs between the computing device and the communication devices to generate and store responses that represent the electronic virtual being engine, based on predetermined queries and new queries from the second communication device, responses to which are received from the first communication device.

An aspect of the present specification provides a method comprising: providing, by a computing device, to a first communication device associated with a first account, one or more predetermined queries stored at one or more memories; receiving, by the computing device, from the first communication device, responses to the one or more predetermined queries; storing, by the computing device, at the one or more memories, the responses associated with respective queries and the first account, the responses representative of an electronic virtual being engine associated with the first account; receiving, by the computing device, from a second communication device, a query associated with the electronic virtual being engine; and responsive to determining a lack of correspondence between the one or more predetermined queries and the query: providing, by the computing device, the query to the first communication device; and responsive to receiving a response to the query from the first communication device, storing, by the computing device, at the one or more memories, the response associated with the query and the first account, the response to further represent the electronic virtual being engine.

Another aspect of the present specification provides a device comprising: a communication interface and a controller, the controller configured to: provide, via the communication interface, to a first communication device associated with a first account, one or more predetermined queries stored at one or more memories; receive, via the communication interface, from the first communication device, responses to the one or more predetermined queries; store, at the one or more memories, the responses associated with respective queries and the first account, the responses representative of an electronic virtual being engine associated with the first account; receive, via the communication interface, from a second communication device, a query associated with the electronic virtual being engine; and responsive to determining a lack of correspondence between the one or more predetermined queries and the query: provide, via the communication interface, the query to the first communication device; and responsive to receiving a response to the query from the first communication device, store, at the one or more memories, the response associated with the query and the first account, the response to further represent the electronic virtual being engine.

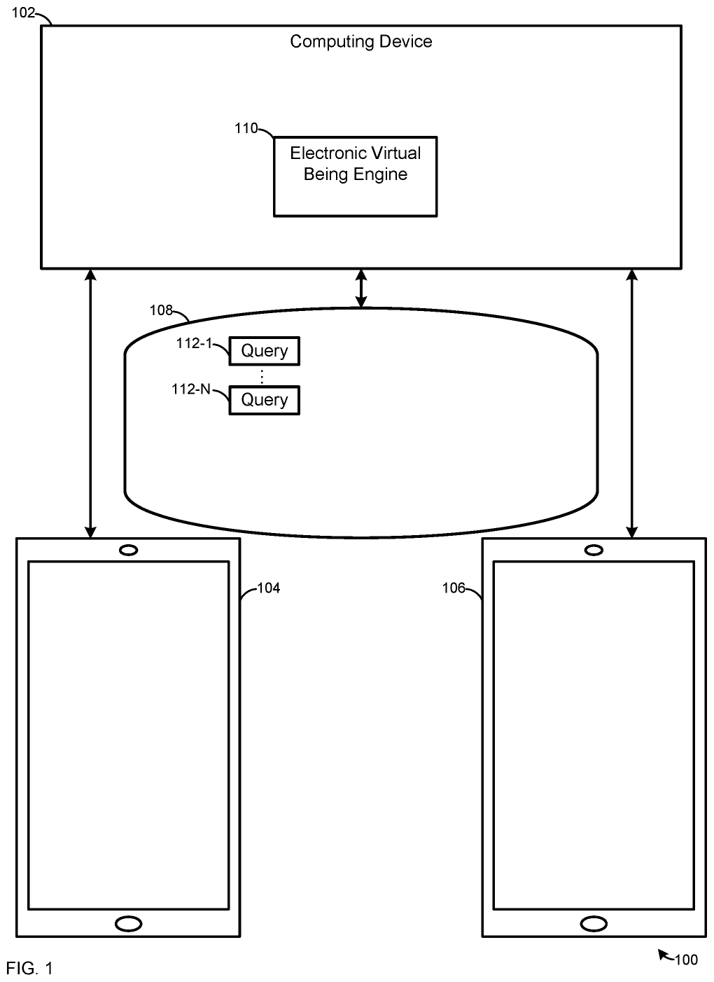

Attention is next directed to FIG. 1, which depicts a system 100 for providing responses to queries. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

Herein, reference will be made to engines, such as electronic virtual being engines and/or chatbot engines, which may be understood to refer to hardware (e.g., a controller, such as a processor, a central processing unit (CPU), an integrated circuit or other circuitry, such as a hardware element with no software elements such as an application specific integrated circuit (ASIC), a Field Programmable Gate Array (FPGA), etc.) or a combination of hardware and software (e.g., a combination of hardware and software includes software hosted at hardware such that the software, when executed by the hardware, transforms the hardware into a special purpose hardware, such as a software module that is stored at a processor-readable memory implemented or interpreted by a processor), or hardware and software hosted at hardware (e.g., programming such as machine- or processor-executable instructions, commands, or code such as firmware, a device driver, programming, object code, etc. as stored on hardware) and/or implemented as a system-on-chip architecture and the like.

As depicted, the system 100 comprises a computing device 102 in communication with a first communication device 104, a second communication device 106 and one or more memories depicted as one memory 108. Hence, hereafter, while references are made to the memory 108, it is understood that such references may include one or more memories 108.

The computing device 102 may comprise, and/or operate, an electronic virtual being engine 110 which may represent a real-world counterpart, and the like, such as an operator (not depicted) of the first communication device 104, and/or another real-world counterpart, among other possibilities (e.g. fictional characters, and the like). In general, the computing device 102 is configured to operate the electronic virtual being engine 110 such that responses to queries, from the second communication device 106, associated with the electronic virtual being engine 110, are provided to the second communication device 106 as representative of electronic virtual being engine 110.

The computing device 102 may be provided in the form of one or more servers and/or cloud computing devices, and the like, which operates the electronic virtual being engine 110 to provide responses to queries to the electronic virtual being engine 110 from the second communication device 106 (and/or other communication devices), as well as populate the memory 108 with such responses.

As depicted, the memory 108, may be provided in form of a database and/or one or more databases) which may be external (e.g. as depicted) and/or internal to the computing device 102. The memory 108 stores an “N” number of a plurality of queries 112-1 . . . 112-N which may be stored as text, and the like and/or in a database format. The plurality of queries 112-1 . . . 112-N will be interchangeably referred to hereafter, collectively, as the queries 112 and, generically, as a query 112. Furthermore, the number “N” of the queries 112 may be any suitable number, and may be organized into categories, as described in more detail below. The queries 112 may be predetermined and/or prepopulated at the memory 108 by an administrator of the system 100. In particular, the queries 112 may be provided in a format for which responses may be generated, and stored to represent the electronic virtual being engine 110; in a particular example, the queries 112 may be in a textual format and/or a database format, which generally consume low bandwidth with provided over communication links as compared to audio and/or video formats. Furthermore, responses to the queries 112, as stored at the memory 108, may be used by the electronic virtual being engine 110 to provide responses to queries received from the second communication device 106. Initially, however, no responses may be stored at the memory 108.

The communication devices 104, 106 may be provided, as depicted, in the form of mobile devices and/or any other suitable communication device including, but not limited to, personal computers, laptop computers, mobile devices, and/or any other suitable type of communication devices.

Furthermore, the communication devices 104, 106 may be associated with accounts at the computing device 102. For example, operators of the communication devices 104, 106 may operate the communication devices 104, 106 (e.g. and/or other communication devices) to open respective accounts with the computing device 102.

As will be explained in more detail below, responses to the queries 112 received in association a particular account may be stored in association with the particular account. For example, the first communication device 104 may be associated with a first account, however more than one communication device may be associated with the first account (e.g. and more than one operator thereof may be associated with the first account). Similarly, responses to the queries 112 received from the first communication device 104 may be stored at the memory 108 in association with the first account, for example as being representative of a real-world counterpart, and the like, to the electronic virtual being engine 110. Hence, the electronic virtual being engine 110 may also be associated with the first account. However, initially, the queries 112 may be generic and not associated with an account.

The second communication device 106 may also be associated with an account (e.g. a second account); while the second communication device 106 is described herein as generating queries associated with the electronic virtual being engine 110 that is associated with the first account (e.g. of the first communication device 104), in other examples, the second communication device 106 may also be associated with an electronic virtual being engine, and the first communication device 104 may generate queries for the electronic virtual being engine of the second communication device 106.

Furthermore, while only two communication devices 104, 106 are depicted, the system 100 may comprise more than two communication devices 104, such as the first communication device 104 and a plurality of second communication devices 106, associated with different operators and/or different accounts, each of which may provide queries associated with the electronic virtual being engine 110.

As mentioned above, the memory 108 may be external and/or internal to the computing device 102; when external, the memory 108 may comprise a component of a further computing device (not depicted), which operates the memory 108.

The electronic virtual being engine 110 may be provided in the form of a chatbot (e.g. a chatbot engine), and the like, which interacts with the communication devices 104, 106 to populate responses to the queries 112, at least by interacting with the first communication device 104, as described below, and provides such responses to the second communication device 106. However, the electronic virtual being engine 110 may alternatively be provided in the form of a machine learning algorithm, and the like, which (e.g. in a learning mode) interacts with the communication devices 104, 106 to populate responses to the queries 112, at least by interacting with the first communication device 104, as described below, and provides such responses to the second communication device 106. Furthermore, the queries 112 and respective responses (as well as queries from the second communication device 106 and respective responses from the first communication device 104) may be used to “train” the machine learning algorithm (e.g. to generate classifiers and the like therefor).

In particular, the computing device 102, for example via operation of the electronic virtual being engine 110, generally provides the queries 112 to the first communication device 104, which may provide the queries 112 at a notification device thereof. Such a notification device may include a display screen which may provide the queries 112 in the form of text, and the like, and/or a speaker which may provide the queries in the form of audio, for example by converting the queries 112 in a text format to audio via a text-to-speech engine, and the like. Hence, in some examples, the computing device 102 may provide the queries 112 to the first communication device 104 as text which may be provided at a display screen thereof and/or converted to audio and provided at a speaker thereof. Alternatively, the computing device 102 may convert text of the queries 112 to audio and transmit the queries 112 as audio to the first communication device 104 which may be provided at a speaker of the first communication device 104; however, in general, transmission of textual queries and textual responses are understood to consume lower bandwidth than audio transmission.

Regardless of format of the queries 112, the queries 112 may be provided at the first communication device 104 in an application (e.g. an “app”) configured to provide the queries 112 at the first communication device 104 and receive responses thereto, and provide the response back to the computing device 102 which stores the responses at the memory 108 in association with respective queries 112 (e.g. a response to a respective query 112 is stored at the memory 108 in association with the respective query 112). The responses may be received in a textual format, and the like, at the first communication device 104, and transmitted back to the computing device 102, and/or the responses may be received in an audio format, and the like, at the first communication device 104, and transmitted back to the computing device 102. In some examples, when responses are received in an audio format at the first communication device 104, the responses may be converted to text (e.g. via a speech-to-text engine at the first communication device 104) prior to transmission to reduce bandwidth usage thereof.

In some examples, voice analysis may occur on responses received in an audio format (e.g. at the first communication device 104 and/or the computing device 102), for example to generate voice data, and the like, such that a voice of the operator of the first communication device 104 may be synthesized via a voice engine and used to electronically generate a voice of the electronic virtual being engine 110 at the second communication device 106. However, audio data used to generate voice data for a voice engine may alternatively be acquired at the first communication device 104 in a voice training mode (e.g. where the operator of the first communication device 104 is asked to speak into a microphone of the first communication device 104 so that voice analysis may occur). Similarly, a camera of the first communication device 104 may be used to acquire images of the operator of the first communication device 104, which may be used to electronically generate an images of the electronic virtual being engine 110 at the second communication device 106 (e.g. as an “avatar” of the electronic virtual being engine 110).

Furthermore, it is understood that the second communication device 106 may also provide a query associated with the electronic virtual being engine 110 to the computing device 102 which may receive the query and determine whether the query corresponds to a predetermined query 112 stored at the memory 108 (e.g. via natural language processing, and the like). Such a query may be received and/or generated at the second communication device 106 in a respective application (e.g. an “app”) configured to provide receive and/or generate queries and provide to the computing device 102, for example as a query for the electronic virtual being engine 110. In the respective application, an avatar of the electronic virtual being engine 110 may be provided to receive queries and/or provide responses, the of the electronic virtual being engine 110 based on the voice and images of the operator of the first communication device 104, as described above.

Hence, in some examples, the electronic virtual being engine 110 may be at least partially implemented via one or more natural language processing (NLP) engines that determine whether a predetermined query 112 corresponds to a query received from the second communication device 106. Hence, the electronic virtual being engine 110 may be configured to determine whether a predetermined query 112 corresponds to a query received from the second communication device 106 using natural language processing by, for example, comparing the query with the one or more predetermined queries 112 to find a correspondence between one or more words of the query and one or more words of training phrases associated with the one or more predetermined queries 112.

Hence, in particular, the one or more predetermined queries 112 may be stored with one training phrase, or a plurality of training phrases, to assist with determining whether a predetermined query 112 corresponds to a query received from the second communication device 106. In some of these examples, the computing device 102 may be further configured to generate such training phrases using a database, and the like, of synonyms, and the like, and/or a database, and the like, of semantic rules for generating training phrases. In particular, an initial training phrase for a query 112 may correspond to a statement of the intent of a query 112, and further training phrases may be generated using synonyms for words of the initial training phrase, and semantic rules, and the like.

When the query received at the computing device 102, from the second communication device 106 does not correspond to a query 112 stored in the memory 108, the computing device 102 may provide the query received from the second communication device 106 to the first communication device 104 which may provide the query via a display screen, a speaker, and the like, receive a response thereto via an input device, and provide the response to the computing device 102. The computing device 102 may store the received response and the query from the second communication device 106 at the memory 108 in association with the first account, to further represent the electronic virtual being engine 110. The computing device 102 may further provide the received response to the second communication device 106 as a response to the query from the second communication device 106.

Later, when a further communication device (not depicted) provides a same and/or similar query to the computing device 102, for example, as a further query to the electronic virtual being engine 110, the computing device 102 may provide the previously received response to the further communication device as being representative of the electronic virtual being engine 110 without providing the further query to the first communication device 104. Hence, in such a manner, with one or more second communication devices 106 providing queries associated with the electronic virtual being engine 110 to the computing device 102, and the computing device 102 providing the queries to the first communication device 104 to receive and store responses thereto at the memory 108 (e.g. when the queries are “new” and/or do not correspond with the predetermined queries 112 and/or other previously received queries), responses to queries associated with the electronic virtual being engine 110 may be efficiently populated at the memory 108.

Other features are within the scope of the present specification.

For example, prior to the second communication device 106 providing a query associated with the electronic virtual being engine 110, the first communication device 104 may provide, to the computing device 102, an authorization for the second communication device 106 to access the electronic virtual being engine, for example in the form of a network address, and the like, associated with the second communication device 106. The computing device 102 may provide, to the second communication device 106, the authorization, for example in the form of a notification to access responses associated with the electronic virtual being engine 110 and/or download an application (e.g. the aforementioned “app”) to interact with the electronic virtual being engine 110. As such, having been authorized, and downloaded the application, an operator of the second communication device 106 may initiate a query for the electronic virtual being engine 110 from the second communication device 106. In some example, receiving query for the electronic virtual being engine 110, at the computing device 102, from the second communication device 106, may occurs only after the authorization is provided to the second communication device 106. In some examples, the second communication device 106 may request such an authorization from the computing device 102 which may mediate the authorization between the communication devices 104, 106.

Another feature within the scope of the present specification may include the computing device 102 comparing a query received from the second communication device 106, that does not correspond to the one or more of the queries 112, to criteria indicative of general queries. Such criteria may include rules for classifying queries as being specific to a particular real-world counterpart of the electronic virtual being engine 110, and the like, or being more general queries. For example, a query associated with a specific location and/or person and/or family member and/or event associated with a particular real-world counterpart of the electronic virtual being engine 110 may be determined to not be a general query via the criteria, while a query not associated with a specific location and/or person and/or family member and/or event associated with a particular real-world counterpart of the electronic virtual being engine 110 may be determined to be a general query via the criteria. In these examples, responsive to a query meeting the criteria: the query may be stored at the memory 108 as another of the one or more predetermined queries 112, such that the query is provided with the one or more predetermined queries 112 to other communication devices associated with other accounts such that respective responses to the query received from the other communication devices are representative of other electronic virtual being engines respectively associated with the other accounts. In this manner, the queries 112 may be further populated.

Another feature within the scope of the present specification may include the first communication device 104 being operated to provide, to the computing device 102, one or more files in association with a tag. The one or more files may comprise one or more of a text file, an image file, a video file, an audio file, and a multimedia file. The tag indicative of a topic with which the one or more files are associated, such as “family”, “politics”, “hobbies” and/or any other suitable topic. The computing device 102 may receive the one or more files in association with the tag and store the one or more files in association with the tag at the memory 108. The one or more files may be representative of an electronic memory-bank on the topic for the electronic virtual being engine 110. As such, the computing device 102 may receive, from the second communication device 106, a request to access at least a portion of the electronic memory-bank on the topic for the electronic virtual being engine; and provide, to the second communication device 106, responsive to determining the request, one or more of the files.

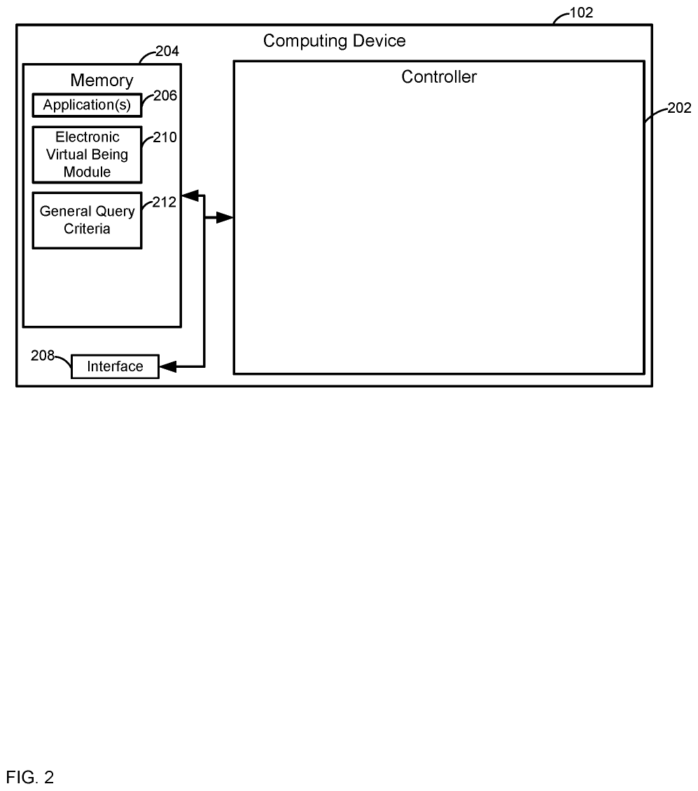

Details of the computing device 102 are now described with respect to FIG. 2.

The computing device 102, can comprise any suitable computing device, including but not limited to servers, cloud computing devices, and the like, and which may include, but are not limited to one or more personal computers, laptops, and the like operating such servers and/or cloud computing devices. In some examples, a portion of the functionality of the computing device 102 may be combined with one or more of the communication devices 104, 106, and/or functionality of the computing device 102 may be provided in a distributed manner in the system 100.

As depicted, the computing device 102 generally comprises: a controller 202; a memory 204 storing one or more applications 206, and a communication interface 208 (interchangeably referred to hereafter as the interface 208). While the memory 204 is depicted as internal to the computing device 102, the memory 204 may be external to the computing device 102 and the controller 202 may have access to the memory 204 via the interface 208. Indeed, the memory 204 may include the memory 108 and/or the memory 204 may be separate from the memory 108.

In general, the electronic virtual being engine 110 may generally comprise a combination of the controller 202 and the memory 204 storing the application 206, and the interface 208, and/or the electronic virtual being engine 110 may generally comprise a combination of the controller 202 and the memory 204 storing an electronic virtual being module 210, and the interface 208. The electronic virtual being module 210 may comprise instructions which, when executed by the controller 202, cause the electronic virtual being engine 110 to be implemented. The electronic virtual being module 210 may be separate from the application 206 and/or the electronic virtual being module 210 may be a component of the application 206. The application 206 may otherwise used to populate the memory 108 with responses and/or queries as described in further detail below.

Each of the one or more applications 206 may be similar, but for a different mode of the computing device 102; for example, in one mode, the computing device 102 may provide the predetermined queries 112 to the first communication device 104 to initially determine at least a portion of responses thereto. In another mode, the computing device 102 may receive queries from the second communication device 106. In yet a further mode, a machine learning algorithm may be trained to implement functionality as describe herein. For simplicity, the one or more applications 206 will be interchangeably referred to hereafter as the application 206. Furthermore, in the various modes, the computing device 102 implementing the application 206 is understood to implement the electronic virtual being module 210, to operate the electronic virtual being engine 110, in any suitable manner. Hence, hereafter, operation of the computing device 102 will be described with reference to the application 206 and the electronic virtual being engine 110.

While not depicted, the computing device 102 may include other suitable components, including, but not limited to, a display screen, an input device and the like, to enable an administrator to interact with the computing device 102; however, such an administrator may alternatively interact with the computing device 102 remotely via the interface 208.

The interface 208 comprises any suitable wired or wireless communication interface configured to communicate with the communication devices 104, 106 and the memory 108. The interface 208 may communicate in a wired and/or wireless manner as desired including, but not limited using cables, Internet-based communication links, WiFi™ communication links, wide area networks, personal area networks, local area networks, and the like.

The controller 202 may comprise a processor and/or a plurality of processors, including but not limited to one or more CPUs and/or one or more graphics processing units (GPUs) and/or one or more processing units; either way, the controller 202 comprises a hardware element and/or a hardware processor. In some implementations, the controller 202 can comprise an ASIC and/or an FPGA specifically configured for providing responses to queries. Hence, the computing device 102 may preferably not be a generic computing device, but a device specifically configured to implement specific functionality for providing responses to queries. For example, the computing device 102 and/or the controller 202 can specifically comprise a computer executable engine, such as the electronic virtual being engine 110, configured to implement functionality for providing responses to queries.

The memory 204 can comprise a non-volatile storage unit (e.g. Erasable Electronic Programmable Read Only Memory (“EEPROM”), Flash Memory) and a volatile storage unit (e.g. random-access memory (“RAM”)). Programming instructions that implement the functional teachings of the computing device 102 as described herein are typically maintained, persistently, in the memory 204 and used by the controller 202, which makes appropriate utilization of volatile storage during the execution of such programming instructions. Those skilled in the art recognize that the memory 204 is an example of computer readable media that can store programming instructions executable on the controller 202. Furthermore, the memory 204 is also an example of a memory unit and/or memory module and/or a non-volatile memory.

In particular, the memory 204 stores the application 206 that, when processed by the controller 202, enables the controller 202 and/or the computing device 102 to: provide to a first communication device associated with a first account, one or more predetermined queries stored at one or more memories; receive, from the first communication device, responses to the one or more predetermined queries; store, at the one or more memories, the responses associated with respective queries and the first account, the responses representative of an electronic virtual being engine associated with the first account; receive, from a second communication device, a query associated with the electronic virtual being engine; and responsive to determining a lack of correspondence between the one or more predetermined queries and the query: provide the query to the first communication device; and responsive to receiving a response to the query from the first communication device, store, at the one or more memories, the response associated with the query and the first account, the response to further represent the electronic virtual being engine.

Additionally, the application 206, when processed by the controller 202, may further enable the controller 202 and/or the computing device 102 to: provide the response to the second communication device, the response provided as representative of the electronic virtual being engine.

The application 206, and/or the electronic virtual being engine 110, may include numerical algorithms configured to implement the functionality as described above.

Alternatively, and/or in addition to numerical algorithms, the application 206, and/or the electronic virtual being engine 110, may include machine learning models and/or algorithms, and the like, which have been trained to implement the functionality as described above.

In particular, machine learning models and/or algorithms of the application 206 and/or the electronic virtual being engine 110 may be trained to determine whether a query received from a second communication device corresponds to a predetermined query 112.

Similarly, the responses to the respective queries 112, as well as responses to queries from the second communication device 106, may be used to train a machine learning algorithm of the electronic virtual being engine 110 to represent a real-world counterpart, and the like. Hence, the responses to the respective queries 112, as well as responses to queries from the second communication device may be used to generate classifiers, neural network layers and/or neurons, and the like.

The one or more machine learning models and/or algorithms of the application 206 and/or the electronic virtual being engine 110 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Furthermore, in examples where the application 206m and/or the electronic virtual being engine 110, includes machine learning models and/or algorithms, and the like, the application 206, and/or the electronic virtual being engine 110, may include a machine learning training module, and the like, in which the computing device 102 is trained to determine whether a query received from a second communication device corresponds to a predetermined query 112 and/or the electronic virtual being engine 110 is trained, using the responses to the respective queries 112, as well as responses to queries from the second communication device, may be used to train a machine learning algorithm of the electronic virtual being engine 110 to represent a real-world counterpart, and the like.

While details of the communication devices 104, 106 are not depicted, the communication devices 104, 106 may have structure similar to the computing device 102, but adapted for their respective functionality and/or including various respective components for implementing such functionality. For example, the communication devices 104, 106 are understood to include a display screen and/or a speaker for providing output corresponding to queries, as described above, and an input device, such as a pointing device and/or a touch screen and/or a microphone, for receiving input corresponding to responses.

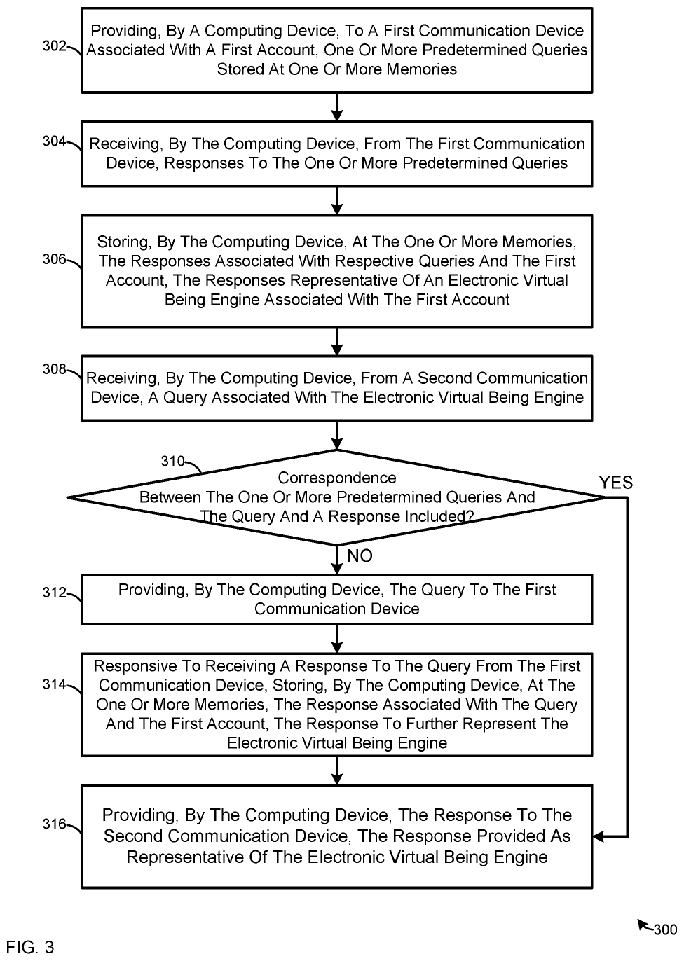

Attention is now directed to FIG. 3, which depicts a flowchart of a method 300 for providing responses to queries according to non-limiting examples. The operations of the method 300 may correspond to machine readable instructions that are executed by the computing device 102, and specifically the controller 202 of the computing device 102. In the illustrated example, the instructions represented by the blocks of FIG. 3 are stored at the memory 204 for example, as the application 206. The method 300 of FIG. 3 is one way in which the controller 202 and/or the computing device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100, as well.

At a block 302, the controller 202 and/or the computing device 102 provides to the first communication device 104 associated with the first account, one or more of the predetermined queries 112 stored at one or more memories 108.

The controller 202 and/or the computing device 102 may provide the queries 112 to the first communication device 104 upon request therefrom (e.g. via an application being operated by the first communication device 104) and/or the controller 202 and/or the computing device 102 may push the queries 112 to the first communication device 104 (e.g. to the application). The queries 112 may be provided in a queue at the first communication device 104 (e.g. in the application) and provided one at a time, such that specific respective responses to queries 112 may be determined.

For example, the controller 202 and/or the computing device 102 may transmit the predetermined queries 112 according to a given order and/or according to the queries 112 as organized into categories, in response to the first communication device 104 being operated to implement an application that provides the queries 112 and receives respective responses to the queries 112.

Put another way, the one or more predetermined queries 112 may be organized into categories, such as “personal information” (e.g. height, weight, eye color, and the like), “family” (e.g. how many siblings), “political views” (e.g. are you right or left), “religious views” (e.g. are you catholic or protestant or atheist), and the like, with a query 112 in a given category for generating a particular response and/or a particular type of response. In some examples, the method 300, at the block 302, may further comprise the controller 202 and/or the computing device 102, providing, to the first communication device 104, the one or more predetermined queries 112 according to the categories.

The first communication device 104 may provide a query 112 (e.g. one at a time) and wait for a response to be received via text, audio, and the like. Alternatively, an operator of the first communication device 104 may decline to provide a response for a particular query 112. An indication of such a declining may be provided to the computing device 102 in place of a response, or no response may be provided to the computing device 102.

However, as a query 112 is provided to the first communication device 104, and a respective response is received at the first communication device 104, the respective response may be transmitted to the computing device 102.

As such, at a block 304, the controller 202 and/or the computing device 102 receives, from the first communication device 104, responses to the one or more predetermined queries 112.

At a block 306, the controller 202 and/or the computing device 102 stores, at the one or more memories 108, the responses associated with respective queries 112 and the first account, the responses representative of the electronic virtual being engine 110 associated with the first account. Hence, as will next be described, the responses received from the first communication device 104, and stored at the memory 108, may be used by the electronic virtual being engine 110 to provide responses to queries received from the second communication device 106 (or other communication devices). However, such an example assumes that a query received from the second communication device 106 corresponds to a query 112 already stored at the memory 108 in association with a response already received from the first communication device 104.

For example, at a block 308, the controller 202 and/or the computing device 102 receives, from the second communication device 106, a query associated with the electronic virtual being engine 110.

At a block 310, the controller 202 and/or the computing device 102 determines whether there is a correspondence between the one or more predetermined queries 112 and the query received, at the block 308, from the second communication device 106.

For example, the query received from the second communication device 106 may be compared to the queries 112 (e.g. and/or associated training phrases) stored at the memory 108 to determine whether there is a correspondence and/or a corresponding query 112. For a correspondence to occur, the query received from the second communication device 106 need not exactly match a query 112; rather, the controller 202 and/or the computing device 102 may use an NLP engine to determine whether the query received from the second communication device 106 corresponds to a query 112 by comparing the query with the one or more predetermined queries to find a correspondence between one or more words of the query and one or more words of training phrases associated with the one or more predetermined queries 112, and the like.

At the block 310, when there is a correspondence between the one or more predetermined queries 112 and the query received from the second communication device 106, the controller 202 and/or the computing device 102 may further determine whether a response to the corresponding query 112 is included at the memory 108. Such a response may be at the memory 108 when the corresponding query 112 has already been provided to the first communication device 104. However, when no response to the corresponding query 112 is included, the corresponding query 112 may not yet have been provided to the first communication device 104, or the operator of the first communication device 104 may have declined to provide a response to the corresponding query 112.

Responsive to determining a lack of correspondence between the one or more predetermined queries 112 and the query, or a response not being included at the memory 108, (e.g. a “NO” decision at the block 310), at a block 312, the controller 202 and/or the computing device 102 provides the query, received from the second communication device 106, to the first communication device 104, as described above.

In some examples, a response to the query provided to the first communication device 104 may not be received; for example, the operator of the first communication device 104 may decline to provide a response.

However, at a block 314, responsive to receiving a response to the query from the first communication device 104, the controller 202 and/or the computing device 102 stores, at the one or more memories 108, the response associated with the query and the first account, the response to further represent the electronic virtual being engine 110.

Hence, it is understood that, the method 300 may further comprise the controller 202 and/or the computing device 102, responsive to determining a correspondence between the one or more predetermined queries 112 and the query received from the second communication device 106, and the one or more memories 108 excluding a response thereto: providing (e.g. at the block 312) the query to the first communication device 104; and responsive to receiving the response to the query from the first communication device 104: storing (e.g. at the block 312) at the one or more memories 108, the response associated with the query and the first account, the response to further represent the electronic virtual being engine 110.

Put another way, the query from the second communication device 106 may be provided to the first communication device 104 in response to at least two conditions: when there is no corresponding query 112 at the memory 108; and when there is a corresponding query 112 but no respective response stored at the memory 108.

In some examples, as depicted, the method 300 may further comprise, at a block 316, the controller 202 and/or the computing device 102, responsive to receiving the response to the query from the first communication device 104, providing the response to the second communication device 106, the response provided as representative of the electronic virtual being engine 110.

Returning to the block 308, responsive to a correspondence between the one or more predetermined queries 112 and the query received from the second communication device 106, and further responsive to a respective response to the corresponding query 112 already being included at the memory 108 (e.g. a “YES” decision at the block 310), the controller 202 and/or the computing device 102 may, at the block 316, provide the respective response to the corresponding query 112 to the second communication device 106, the response provided as representative of the electronic virtual being engine 110. Hence, in these examples, a response to the query received from the second communication device 106 may be provided using a predetermined response to the corresponding query 112, without further communicating with the first communication device 104.

Put another way, the method 300 may further comprise, the controller 202 and/or the computing device 102, responsive to determining a correspondence between the one or more predetermined queries 112 and the query received from the second communication device 106, and a respective response to the query (e.g. received from the second communication device 106) already being stored at the one or more memories 108: providing, by the controller 202 and/or the computing device 102, the respective response to the second communication device 106, the respective response provided as representative of the electronic virtual being engine 110.

Other features are within the scope of the method 300. For example, the method 300 may further comprise the controller 202 and/or the computing device 102: receiving, from the first communication device 104, an authorization for the second communication device 106 to access the electronic virtual being engine 110; and providing, to the second communication device 106, the authorization. In some of these examples, receiving the query for the electronic virtual being engine 110 from the second communication device 106, at the block 308, may occurs only after the authorization is provided to the second communication device 106.

In yet further examples, the method 300 may further comprise the controller 202 and/or the computing device 102: receiving, from the first communication device 104, one or more files in association with a tag; the one or more files comprising one or more of a text file, an image file, a video file, an audio file, and a multimedia file; the tag indicative of a topic with which the one or more files are associated; and storing, at the one or more memories 108, the one or more files in association with the tag, the one or more files further representative of an electronic memory-bank on the topic for the electronic virtual being engine 110. Hence, the method 300 may yet further comprise the controller 202 and/or the computing device 102: receiving, from the second communication device 106, a request to access at least a portion of the electronic memory-bank on the topic for the electronic virtual being engine 110; and providing, to the second communication device 106, responsive to determining the request, one or more of the files.

In yet further examples, the method 300 may further comprise the controller 202 and/or the computing device 102: responsive to determining the one or more predetermined queries 112 excludes the query: comparing the query to the criteria 212 indicative of general queries; and responsive to determining the query meeting the criteria 212: storing the query at the one or more memories 108 as another of the one or more predetermined queries 112, such that the query is provided with the one or more predetermined queries 112 to other communication devices associated with other accounts such that respective responses to the query received from the other communication devices are representative of other electronic virtual being engines respectively associated with the other accounts.

In yet further examples, the method 300 may further comprise the controller 202 and/or the computing device 102: receiving one or more of voice data, image data and video data of an operator of the first communication device 104 to generate one or more of a voice, images and video representative of the electronic virtual being engine 110. In some examples, one or more responses to queries 112 from the first communication device 104 may comprises one or more of the voice data, the image data and the video data (e.g. one or more of the voice data, the image data and the video data may be acquired in conjunction with receiving the responses).

In yet further examples, the method 300 may further comprise the controller 202 and/or the computing device 102: receiving, from the first communication device 104, a plurality of responses for a predetermined query 112 and/or the query from the second communication device 106, and storing, at the one or more memories 108, the plurality of responses in association with the predetermined query 112 and/or the query from the second communication device 106. In such examples, the method 300 may further comprise the controller 202 and/or the computing device 102: providing, to the second communication device 106, in response to the query (e.g. received at the block 308 from the second communication device 106) one response, of the plurality of responses; the one response may be randomly selected from the plurality of responses and/or the computing device 102 may cycle through the plurality of responses (e.g. as same and/or similar queries are received from various communication devices, the computing device 102 may provide a first response, then a second response, then a third response, etc. in response, until a last response is reached, at which point the computing device 102 may again provide the first response).

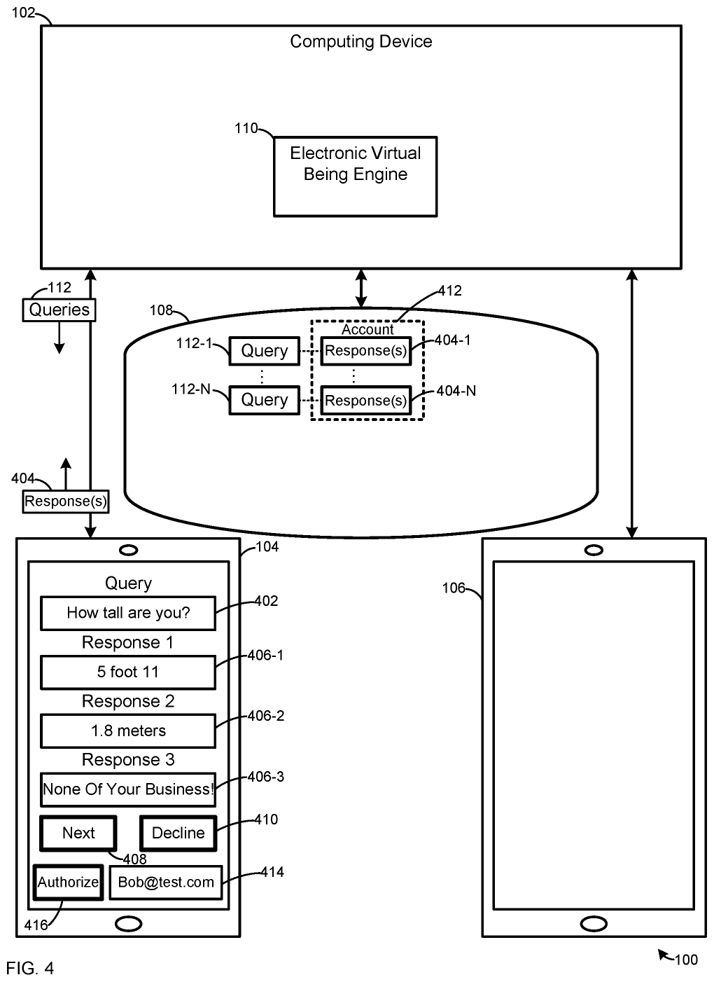

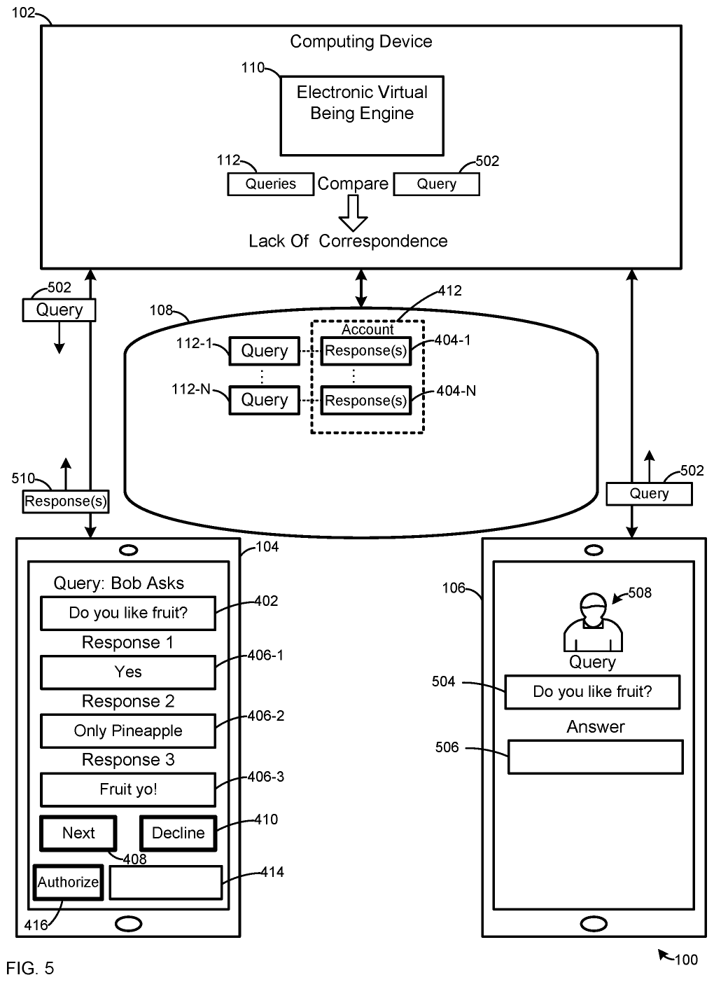

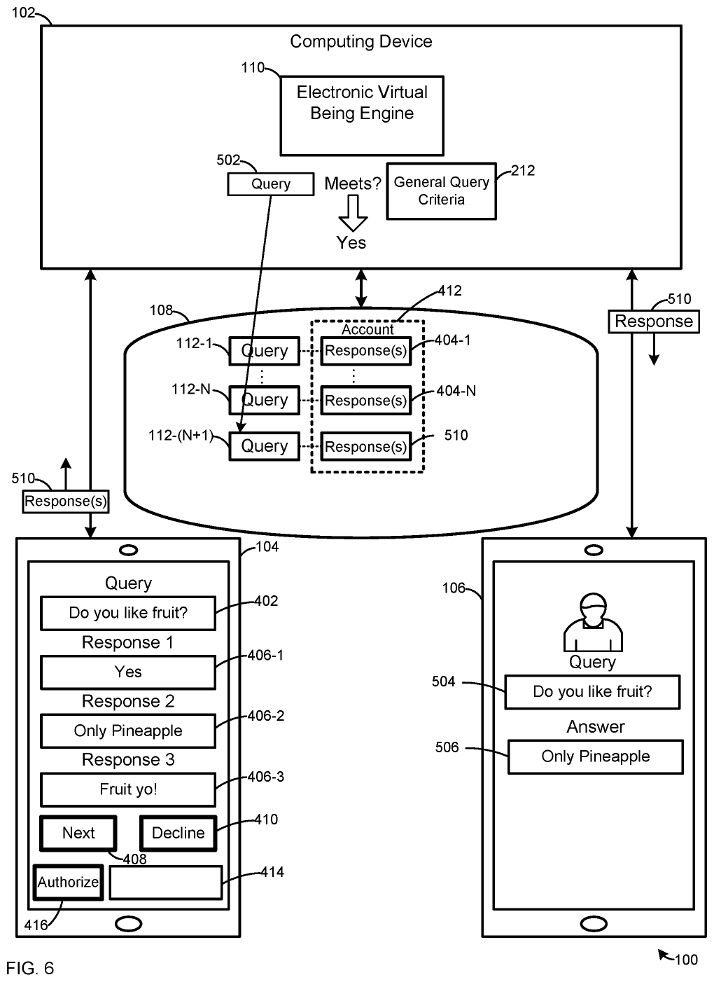

Attention is next directed to FIG. 4, FIG. 5, and FIG. 6 which depict aspects of the method 300. FIG. 4, FIG. 5, and FIG. 6 are substantially similar to FIG. 1, with like components having like numbers.

Attention is first directed to FIG. 4, at which the first communication device 104 is depicted as operating an application, rendered at a display screen, associated with the electronic virtual being engine 110 and/or for communicating with the computing device 102. In particular, the computing device 102 provides (e.g. at the block 302 of the method 300) the predetermined queries 112 to the first communication device 104 via the application, which may render the queries 112 (e.g. one at a time) at a display screen thereof. For example, as depicted, a particular query 112 is provided at a field 402, and one or more responses 404 may be received at respective fields 406-1, 406-2, 406-3 (e.g. fields 406 and/or a field 406). While three fields 406 (e.g. for three responses to the particular query 112 provided the field 402) are depicted, as few as one field 406 may be provided (e.g. for one response 404 to the particular query 112 provided the field 402) and/or other numbers of fields 406 may be provided (e.g. for other numbers of responses to the particular query 112 provided the field 402). Furthermore, when there is more than one field 406, a response 404 may be provided in only one of the fields 406 and/or a number of the responses 404 may be fewer than a number of the fields 406. Regardless, the responses 404 may be received at the fields 406 as text (e.g. via a keyboard, not depicted) and/or via speech-to-voice (e.g. via a microphone, not depicted) and the like.

As depicted, an electronic button 408 (e.g. labelled “Next”) at the first communication device 104 may be actuated to cause the responses 404 received at one or more of the fields 406 (e.g. for each query 112 provided at the provided at the field 402) to be provided to the computing device 102. Alternatively, an electronic button 410 (e.g. labelled “Decline”) may be actuated which may cause the next query 112 to be provided at the field 402 and no responses 404 to be provided to the computing device 102.

Actuation of the electronic button 408 may also cause a next query 112 to be provided at the field 402 and respective responses 404 thereto to be received at one or more of the fields 406, which may also be transmitted to the computing device 102.

As depicted, the computing device 102 receives (e.g. at the block 304 of the method 300) the respective responses 404 (e.g. to the queries 112) and stores (e.g. at the block 306 of the method 300) the respective responses at the memory 108 in association with respective queries 112, as indicated by dashed lines between the queries 112 and respective responses 404-1 . . . 404-N.

Hence, as depicted, one or more responses 404-1 have been received for the query 112-1, and one or more responses 404-N have been received for the query 112-N, and stored at the memory 108. It is understood, in the depicted example, that all the queries 112 at the memory 108 are stored in association with respective responses 404 associated with a first account 412 that is also associated with the first communication device 104 and the electronic virtual being engine 110.

As depicted, a field 414 is provided at the display screen of the first communication device 104 for receiving (e.g. via an input device) a network address (e.g. “Bob@test.com”), and the like, of the second communication device 106, and an associated electronic button 416 (e.g. labelled “Authorize”) at the first communication device 104 may be actuated to authorize the second communication device 106 via the received network address. While not depicted, when the associated electronic button 416 is actuated, the computing device 102 may be provided with of the network address at the field 414, and notify the second communication device 106 of the authorization, which may cause the second communication device 106 to retrieve an associated application for providing queries to the electronic virtual being engine 110.

For example, as depicted in FIG. 5, the second communication device 106 is operating such an associated application to provide a query 502 (e.g. “Do you like fruit?”) associated with the electronic virtual being engine 110, for example at a field 504. A field 506 for providing a response to the query 502 is also rendered at the display screen, as well as an image 508 representing the electronic virtual being engine 110, which may comprise an image (e.g. which may be animated and/or may comprise an avatar, and the like) of an operator of the first communication device 104.

The query 502 is transmitted to the computing device 102 which receives the query 502 (e.g. at the block 308 of the method 300), and compares the predetermined queries 112 with the query 502 to determine (e.g. at the block 310 of the method 300) whether there is a correspondence between one or more of the predetermined queries 112 and the query 502; such a determination may be performed via a database lookup, and the like and/or via comparing the query 502 with one or more training phrases of the predetermined queries 112.

As depicted, the computing device 102 determines (e.g. a “NO” decision at the block 310 of the method 300), that there is a lack of correspondence between the predetermined queries 112 and the query 502; put another way, none of the predetermined queries 112 are the same as, and/or similar to, the query 502. Hence, the computing device 102 provides (e.g. at the block 312 of the method 300) the query 502 to the first communication device 104, which provides the query 502 at the field 402; as depicted, a label of the field 402 is modified to identify how the query 502 originated (e.g. “Bob asks”, presuming “Bob” is associated with the second communication device 106; the label of the field 402 may be modified based, at least in part, on the network identifier previously received at the field 414, and/or metadata received with the query 502, among other possibilities).

As depicted, one or more responses 510 to the query 502 may be received at the fields 406, as described above, and the one or more responses 510 are transmitted to, and received at the computing device 102.

Attention is next directed to FIG. 6 which depicts the computing device storing (e.g. at the block 312 of the method 300), the one or more responses 510 at the memory 108 in association with the query 502, and the first account 412. As depicted, the query 502 is optionally compared with the criteria 212, indicative of general queries, to determine whether query 502 meets the criteria 212. As the query 502 is of a general nature (e.g. does not mention a specific place, a specific friend, a specific family member, and/or a specific personal event, and the like), the query 502 is determined to meet the criteria 212 and is hence stored as a new predetermined query 112-(N+1) in association with the one or more responses 510. However, if the query 502 had not met the criteria 212, the query 502 would be stored at the memory 108 in association with the first account 412 and not stored as a predetermined query 112.

As also depicted in FIG. 6, the computing device 102 provides (e.g. at the block 314 of the method 300), one of the responses 510 to the second communication device 106, which provides the response 510 in the field 506; alternatively, the response 510 may be converted to audio and played at a speaker of the second communication device 106 (e.g. as a synthesized voice of the operator of the first communication device 104). As depicted, the computing device 106 has randomly selected the response 510 received at the field 406-2 to provide to the second communication device 106.

While the example of FIG. 4, FIG. 5 and FIG. 6 is shown as a “real-time” example, with the response 510 being provided without a significant delay after the query 502 is transmitted, providing of the response 510 may be asynchronous with the query 502 being transmitted from the second communication device 106. For example, the query 502 may be transmitted from the second communication device 106 on a given day, and placed into a query queue at the first communication device 104, with the response(s) 510 being provided at the first communication device 104 on another day. Hence, when the response 510 is provided to the second communication device 106, a notification of receipt the response 510 may be provided at the second communication device 106 to cause the respective application to be opened such that the response 510 may be provided as shown in FIG. 6.

In some further examples, the fields 504, 506 may be provided in the application at the first communication device 104 (e.g. operating in a self-query mode), such that the first communication device 104 may also provide queries associated with the electronic virtual being 110 (e.g. via the field 504). When such a query corresponds to a query 112, an associated response 404 is provided back to the first communication device 104. Similarly, when a lack of correspondence is found between such a query and the queries 112 (and/or when a correspondence is found but no response is found, as described above) such a query is provided back to the first communication device 104 and placed into a query queue at the first communication device 104; hence, when the first communication device 104 is later operated in the mode depicted in FIG. 6, one or more responses to such a query may be generated. As such, the first communication device 104 may also generate queries and associated responses in a feedback loop with itself operating in different modes.

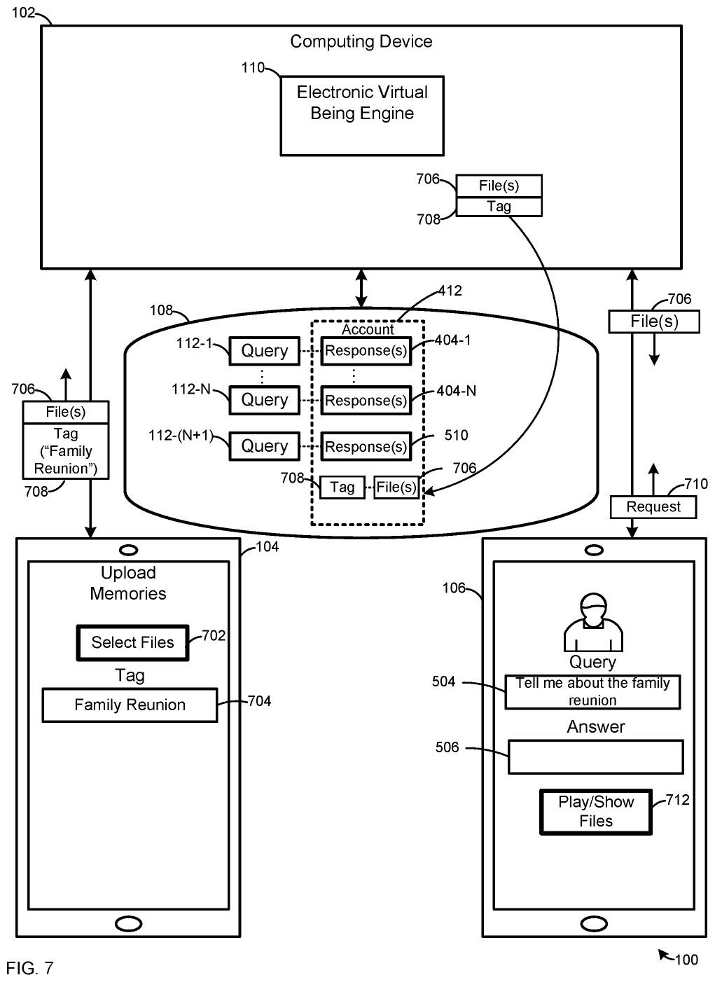

Attention is next directed to FIG. 7 which depicts another aspect of the present specification. In particular, the first communication device 104 is being controlled to provide another view of the application associated with the electronic virtual being engine 110 (e.g. which may be accessed via a menu system, not depicted). In particular, an electronic button 702 is provided to select one or more files (e.g. stored at the first communication device 104 and/or accessible and/or available to the first communication device 104) that may be tagged via a field 704 as being indicative of a topic with which the one or more files are associated. For example, as depicted one or more files 706 may be selected and associated with a tag 708 of a “Family Reunion” (e.g. received at the field 704) and transmitted to the computing device 102, which stores the one or more files 706 in association with the tag 708. For example, the one or more files 706 may include, but is not limited to a text file, an image file, a video file, an audio file, and a multimedia file, and the like. The one or more files 706 may represent an electronic memory-bank on the topic indicated by the tag 708 for the electronic virtual being engine 110.

As depicted, at the second communication device 106, a request 710 to access the one or more files 706 may be generated (e.g. as received at the field 504 and/or another field) and transmitted to the computing device 102, which may provide one or more of the files 706 to the second communication device 106 in response to the request 710; for example, text in the request 710 (e.g. “family reunion”) may be compared with the tag 708 to determine a correspondence therebetween.

The computing device 102 may be further configured to distinguish requests to access the one or more files 706 from queries, for example on the basis of text, and the like, in such requests and queries, and/or using machine learning techniques, and/or by the second communication device 106 including metadata and the like, of such requests and queries. As depicted, the second communication device 106 may “play”, and the like, the one or more of the files 706, as received, via an electronic button 712. However, the one or more of the files 706, as received may be played and/or accessed in any suitable manner.

Hence, provided herein is a device, system and method for providing responses to queries, and which may further build a database, and the like, of responses to predetermined queries associated with an electronic virtual being engine, as well as populate the database with new queries, and responses thereto. As such, a technical solution to a technical problem of efficiently populating a database and/or a memory with both queries, and responses to queries, may be provided; in particular, the physical nature of the memory 108 is materially changed via techniques provided herein, and operation of the computing device 102 and/or the electronic virtual being engine 110 may be made more efficient. In particular, population of a database and/or the memory 108 with both queries, and responses to queries, provides a clear technical effect of changing the memory 108, and further changing operation of the computing device 102/or the electronic virtual being engine 110, for example, by expanding a range of queries to which the electronic virtual being engine 110 may respond. For example, without implementation of the techniques described herein, when a query associated with the electronic virtual being engine 110 is received, for which there is no associated response, a null result and/or an error may occur. Furthermore, by adding generic queries to the database of queries, more efficient population of a database and/or memory with associated responses for other electronic virtual being engines may occur.

As should be apparent from the present specification, the functionality of computing devices described herein are sufficiently complex as to require their implementation on such computing devices and/or computing systems, and cannot, as a practical matter, be performed in the human mind. In particular, computing devices described herein are understood to include electronic components, which provide speed, accuracy and complexity management that are not obtainable by human mental steps, in addition to the inherently digital nature of such operations. For example, a human mind cannot interface directly with computer memory, digital storage, and the like. Similarly, a human mind cannot transmit and/or receive electronic messages, electronically encoded video, electronically encoded audio, etc., among other features and functions set forth herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or counterpart communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
providing, by a computing device, to a first communication device associated with a first account, one or more predetermined queries stored at one or more memories;
receiving, by the computing device, from the first communication device, responses to the one or more predetermined queries;
storing, by the computing device, at the one or more memories, the responses associated with respective queries and the first account, the responses representative of an electronic virtual being engine associated with the first account;
receiving, by the computing device, from a second communication device, a query associated with the electronic virtual being engine; and
responsive to determining a lack of correspondence between the one or more predetermined queries and the query:
providing, by the computing device, the query to the first communication device; and
responsive to receiving a response to the query from the first communication device, storing, by the computing device, at the one or more memories, the response associated with the query and the first account, the response to further represent the electronic virtual being engine.

2. The method of claim 1, further comprising, responsive to receiving the response to the query from the first communication device:
providing, by the computing device, the response to the second communication device, the response provided as representative of the electronic virtual being engine.

3. The method of claim 1, further comprising, responsive to determining a correspondence between the one or more predetermined queries and the query, and a respective response to the query already being stored at the one or more memories:
providing, by the computing device, the respective response to the second communication device, the respective response provided as representative of the electronic virtual being engine.

4. The method of claim 1, further comprising, responsive to determining a correspondence between the one or more predetermined queries and the query, and the one or more memories excluding the response:
providing, by the computing device, the query to the first communication device; and
responsive to receiving the response to the query from the first communication device: storing, by the computing device, at the one or more memories, the response associated with the query and the first account, the response to further represent the electronic virtual being engine.

5. The method of claim 1, further comprising:
determining whether a predetermined query corresponds to the query using natural language processing: by comparing the query with the one or more predetermined queries to find a correspondence between one or more words of the query and one or more words of training phrases associated with the one or more predetermined queries.

6. The method of claim 1, further comprising:
receiving, from the first communication device, one or more files in association with a tag; the one or more files comprising one or more of a text file, an image file, a video file, an audio file, and a multimedia file; the tag indicative of a topic with which the one or more files are associated; and
storing, at the one or more memories, the one or more files in association with the tag, the one or more files further representative of an electronic memory-bank on the topic for the electronic virtual being engine.

7. The method of claim 6, further comprising:
receiving, by the computing device, from the second communication device, a request to access at least a portion of the electronic memory-bank on the topic for the electronic virtual being engine; and
providing, to the second communication device, responsive to determining the request, one or more of the files.

8. The method of claim 1, wherein, the one or more predetermined queries are organized into categories, and the method further comprises providing, to the first communication device, the one or more predetermined queries according to the categories.

9. The method of claim 1, further comprising:
receiving, from the first communication device, an authorization for the second communication device to access the electronic virtual being engine; and
providing, to the second communication device, the authorization,
wherein receiving the query for the electronic virtual being engine from the second communication device occurs only after the authorization is provided to the second communication device.

10. The method of claim 1, further comprising, responsive to determining the one or more predetermined queries excluding the query:
comparing the query to criteria indicative of general queries; and
responsive to determining the query meeting the criteria: storing the query at the one or more memories as another of the one or more predetermined queries, such that the query is provided with the one or more predetermined queries to other communication devices associated with other accounts such that respective responses to the query received from the other communication devices are representative of other electronic virtual being engines respectively associated with the other accounts.

11. A device comprising:
a communication interface; and
a controller configured to:
provide, via the communication interface, to a first communication device associated with a first account, one or more predetermined queries stored at one or more memories;
receive, via the communication interface, from the first communication device, responses to the one or more predetermined queries;
store, at the one or more memories, the responses associated with respective queries and the first account, the responses representative of an electronic virtual being engine associated with the first account;
receive, via the communication interface, from a second communication device, a query associated with the electronic virtual being engine; and
responsive to determining a lack of correspondence between the one or more predetermined queries and the query:
provide, via the communication interface, the query to the first communication device; and
responsive to receiving a response to the query from the first communication device, storing, at the one or more memories, the response associated with the query and the first account, the response to further represent the electronic virtual being engine.

12. The device of claim 11, wherein the controller is further configured to, responsive to receiving the response to the query from the first communication device:
provide the response to the second communication device, the response provided as representative of the electronic virtual being engine.

13. The device of claim 11, wherein the controller is further configured to, responsive to determining a correspondence between the one or more predetermined queries and the query, and a respective response to the query already being stored at the one or more memories:
provide the respective response to the second communication device, the respective response provided as representative of the electronic virtual being engine.

14. The device of claim 11, wherein the controller is further configured to, responsive to determining a correspondence between the one or more predetermined queries and the query, and the one or more memories excluding the response:
provide the query to the first communication device; and
responsive to receiving the response to the query from the first communication device: store at the one or more memories, the response associated with the query and the first account, the response to further represent the electronic virtual being engine.

15. The device of claim 11, wherein the controller is further configured to:
determine whether a predetermined query corresponds to the query using natural language processing: by comparing the query with the one or more predetermined queries to find a correspondence between one or more words of the query and one or more words of training phrases associated with the one or more predetermined queries.

16. The device of claim 11, wherein the controller is further configured to:
receive, from the first communication device, one or more files in association with a tag; the one or more files comprising one or more of a text file, an image file, a video file, an audio file, and a multimedia file; the tag indicative of a topic with which the one or more files are associated; and
storing, at the one or more memories, the one or more files in association with the tag, the one or more files further representative of an electronic memory-bank on the topic for the electronic virtual being engine.

17. The device of claim 16, wherein the controller is further configured to:
receive, from the second communication device, a request to access at least a portion of the electronic memory-bank on the topic for the electronic virtual being engine; and
providing, to the second communication device, responsive to determining the request, one or more of the files.

18. The device of claim 11, wherein, the one or more predetermined queries are organized into categories, and the controller is further configured to provide, to the first communication device, the one or more predetermined queries according to the categories.

19. The device of claim 11, wherein the controller is further configured to:
receive, from the first communication device, an authorization for the second communication device to access the electronic virtual being engine; and
provide, to the second communication device, the authorization,
wherein receiving the query for the electronic virtual being engine from the second communication device occurs only after the authorization is provided to the second communication device.

20. The device of claim 11, wherein the controller is further configured to, responsive to determining the one or more predetermined queries excluding the query:
compare the query to criteria indicative of general queries; and
responsive to determining the query meeting the criteria: store the query at the one or more memories as another of the one or more predetermined queries, such that the query is provided with the one or more predetermined queries to other communication devices associated with other accounts such that respective responses to the query received from the other communication devices are representative of other electronic virtual being engines respectively associated with the other accounts.
